(19) United States
(12) Patent Application Publication
(10) Pub. No.: US 2023/0303280 A1
(43) Pub. Date: Sep. 28, 2023

(54) BAGGER SYSTEM AND METHOD OF OPERATION

(71) Applicant: HOLLYMATIC CORPORATION, Countryside, IL (US)

(72) Inventor: Victor GUYNN, Romeoville, IL (US)

(73) Assignee: HOLLYMATIC CORPORATION, Countryside, IL (US)

(21) Appl. No.: 18/022,830

(22) PCT Filed: Aug. 30, 2021
(86) PCT No.: PCT/US2021/048212

§ 371 Date: Feb. 23, 2023

Related U.S. Application Data
(60) Provisional application No. 63/071,521, filed on Aug. 28, 2020.

(51) Int. Cl. B65B 43/04; B65B 9/13; B65B 41/14; B65B 61/06; B65B 59/00; B65B 59/02

(52) U.S. Cl. CPC B65B 43/04; B65B 9/13; B65B 41/14; B65B 61/06; B65B 59/001; B65B 59/02; B65B 2210/04

(57) ABSTRACT

Systems and methods for a bagger are provided. The bagger includes a support frame including two rails; a movable portion including a seal system and a gripper system, the movable portion attached to the two rails of the support frame; actuators including a first actuator and a second actuator, the first actuator and the second actuator each configured to move the movable portion along a respective rail of the two rails of the support frame, simultaneously; and a roller configured to hold a roll of film, the roller connected to a portion of the support frame that is above the two rails, wherein the gripper system includes at least one body that is configured to grip the film, and the seal system includes a seal bar that is configured to heat seal opposite side faces of the film together so as to form a first end of a bag.

### CROSS-REFERENCE TO THE RELATED APPLICATION

This application claims priority to U.S. Provisional Application No. 63/071,521, filed Aug. 28, 2020, the contents of which are incorporated herein in its entirety by reference.

### FIELD

Embodiments of the present disclosure are directed to a bagger system and method of operation thereof.

### SUMMARY

According to an embodiment, a bagger includes a non moving top gripper with two air actuated cylinders, a moving gripper attached to mounts of linear actuators and also attached to two air actuated cylinders, an air actuated flying knife, an air actuated seal bar (e.g a seal bar patented by Rollstock), a printer head, and a lower vacuum bar air actuated gripper/opener.

According to an embodiment, after a start button is pressed, the moving gripper closes and brings tube stock film to an entered length or a length set from a scanner plus any offsets. The moving gripper may then be opened and a slight amount of air is blown on the backside of the material to avoid accidental gripping or movement while the moving gripper moves to the soon to be sealed end (e.g. upward). Once the position is reached, the moving gripper is closed along with the top (holding) gripper. The moving gripper then tensions the tube stock film by pulling the tube stock film downward until tension is achieved. While tension is being achieved, the seal bar is fired for a set amount of time and pressure. During the seal, the vacuum aided grippers will grip the bag end for presentation and the flying knife is then actuated to cut the tube stock film.

According to one or more embodiments, a bagger is provided. The bagger includes: a support frame including two rails; a movable portion including a seal system and a gripper system, the movable portion attached to the two rails of the support frame; actuators including a first actuator and a second actuator, the first actuator and the second actuator each configured to move the movable portion along a respective rail of the two rails of the support frame, simultaneously; and a roller configured to hold a roll of film, the roller connected to a portion of the support frame, wherein the gripper system includes at least one body that is configured to grip the film, and the seal system includes a seal bar that is configured to heat seal opposite side faces of the film together so as to form a first end of a bag.

According to one or more embodiments, a method of forming a bag from a film by using a bagger is provided. The method includes: controlling a gripper system of the bagger to move a predetermined amount along two rails of the bagger in a first direction to a first position while gripping the film; controlling the gripper system, after the gripper system reaches the first position, to ungrip the film and move to a second position in a second direction, opposite to the first direction; controlling the gripper system, after the gripper system reaches the second position, to grip the film and tension the film; controlling a sealing device of the bagger, while the film is tensioned by the gripper system, to seal a portion of the film, the portion of the film corresponding to a first end of the bag; and controlling a cutting device of the bagger to separate the bag from another portion of the film.

### BRIEF DESCRIPTION OF THE DRAWINGS

Further features, the nature, and various advantages of the disclosed subject matter will be more apparent from the following detailed description and the accompanying drawings in which:

FIG. 1 illustrates a front view of a bagger of an embodiment.

FIG. 2 illustrates a side view of the bagger of the embodiment illustrated in FIG. 1, in which a portion of a tube stock film is unrolled.

FIG. 3 illustrates a front view of a bagger of an embodiment.

FIG. 4 illustrates a perspective view of a rail, and a pulley system associated therewith, of an embodiment.

FIG. 5 illustrates a front view of the rail, and the pulley system associated therewith, of the embodiment illustrated in FIG. 4.

FIG. 6 illustrates a side view of the rail, and the pulley system associated therewith, of the embodiment illustrated in FIG. 4.

FIG. 7 illustrates a rear view of the rail, and the pulley system associated therewith, of the embodiment illustrated in FIG. 4.

FIG. 8 illustrates a perspective view of a component of the pulley system.

FIG. 9 illustrates a side view of the component of the pulley system.

FIG. 10 illustrates a first stage of a process performed by a bagger of an embodiment.

FIG. 11 illustrates a second stage of the process performed by a bagger of an embodiment.

FIG. 12 illustrates a third stage of the process performed by a bagger of an embodiment.

FIG. 13 illustrates a fourth stage of the process performed by a bagger of an embodiment.

FIG. 14 illustrates a fifth stage of the process performed by a bagger of an embodiment.

FIG. 15 illustrates a sixth stage of the process performed by a bagger of an embodiment.

FIG. 16 illustrates a perspective view of a 3D model of the bagger illustrated in FIG. 1.

FIG. 17 is a diagram that illustrates a bagger system, including some aspects of a bagger, according to embodiments of the present disclosure

### DETAILED DESCRIPTION

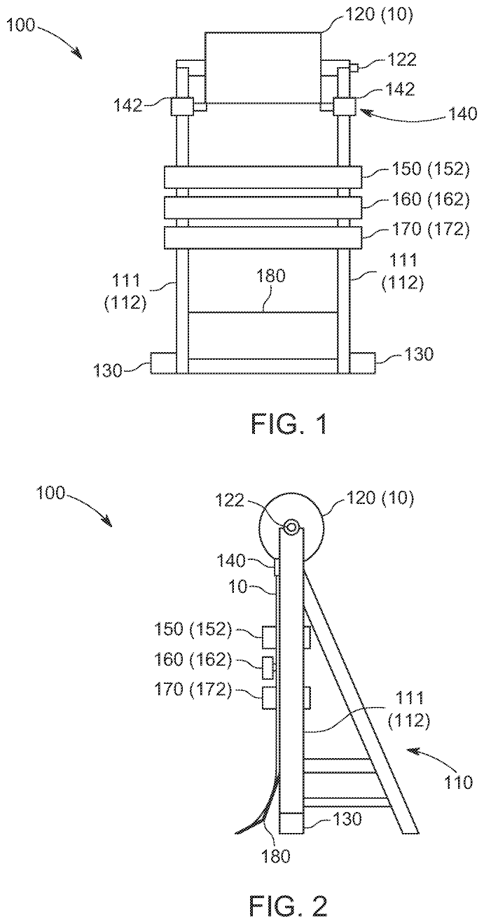

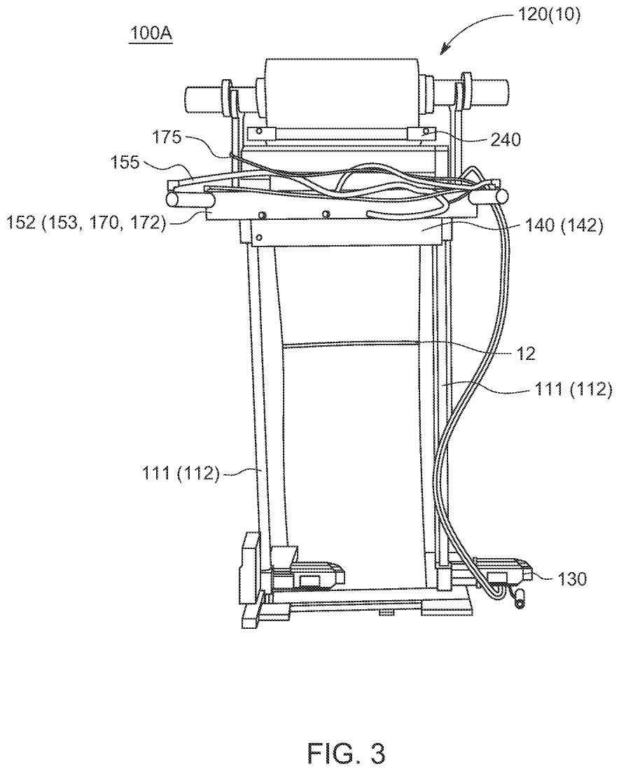

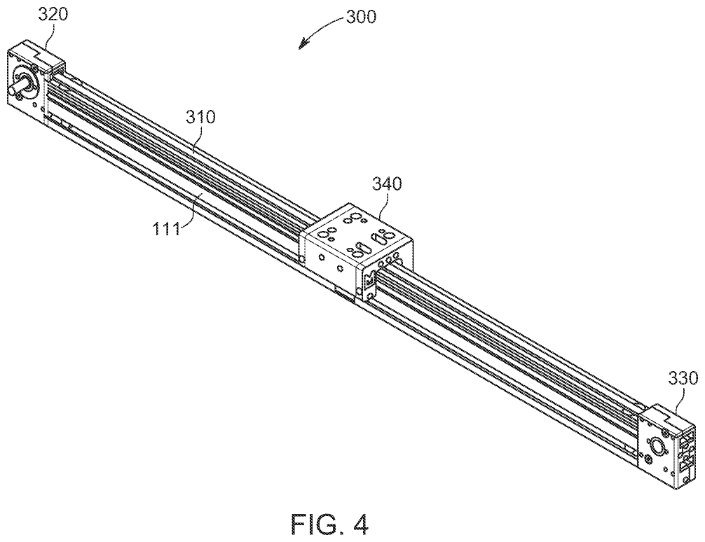

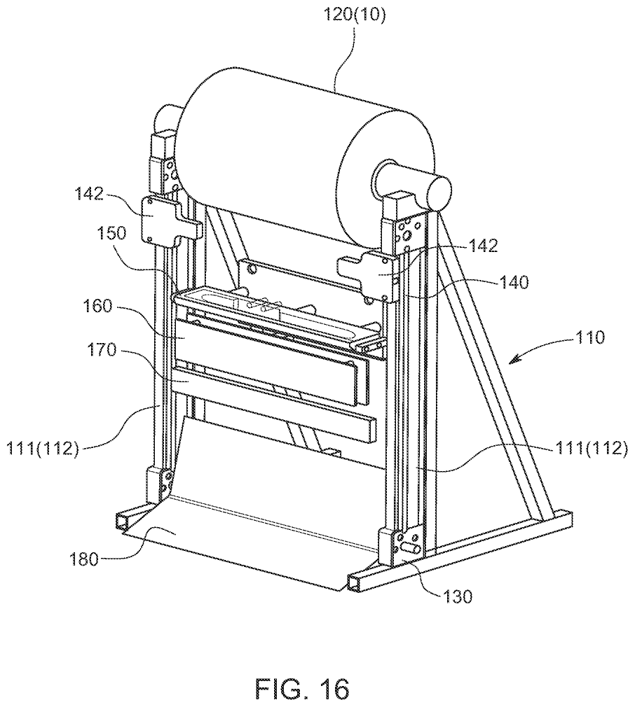

With reference to FIGS. 1-3 and 16, baggers of the present disclosure are described. FIG. 1 illustrates a front view of a bagger 100 of an embodiment. FIG. 2 illustrates a side view of the bagger 100 of the embodiment illustrated in FIG. 1, in which a portion of a tube stock film is unrolled. FIG. 3 illustrates a front view of a bagger 100A of an embodiment, of which aspects described with reference to the bagger 100 may be incorporated, or from which aspects may be incorporated into the bagger 100. FIG. 16 illustrates a perspective view of a 3D model of the bagger 100 illustrated in FIG. 1.

According to an embodiment, a bagger 100 may comprise a support frame 110, one or more rollers 120, one or more motors 130, a movable gripper system 140, a seal system 150, a print head bracket 160, a cutter 170, and a bag chute 180.

The support frame 110 may support components of the bagger 100, such as but not limited to the one or more rollers 120, the one or more motors 130, the movable gripper system 140, the seal system 150, the print head bracket 160, the cutter 170, a tension knob 122, and the bag chute 180. The support frame 110 may include, for example, two rails 111 that are configured to movably support opposite ends of a movable portion of the bagger 100 such that the movable portion may move along extending directions of the rails 111 (e.g. upward and downward). Each of the two rails 111 may be, for example, an extruded frame part of the support frame 110 for holding a respective actuator 112 among actuators (e.g. two actuators). The extruded frame part may be for mounting and option adjustment through the use of T slot nuts and bolts.

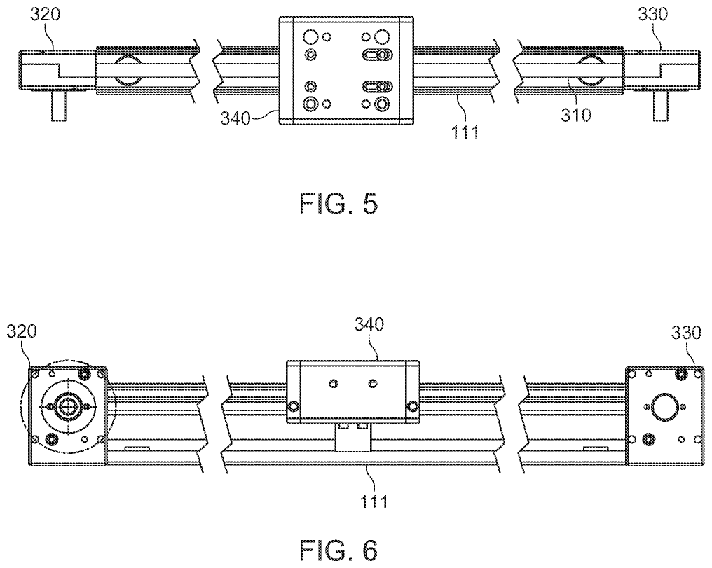

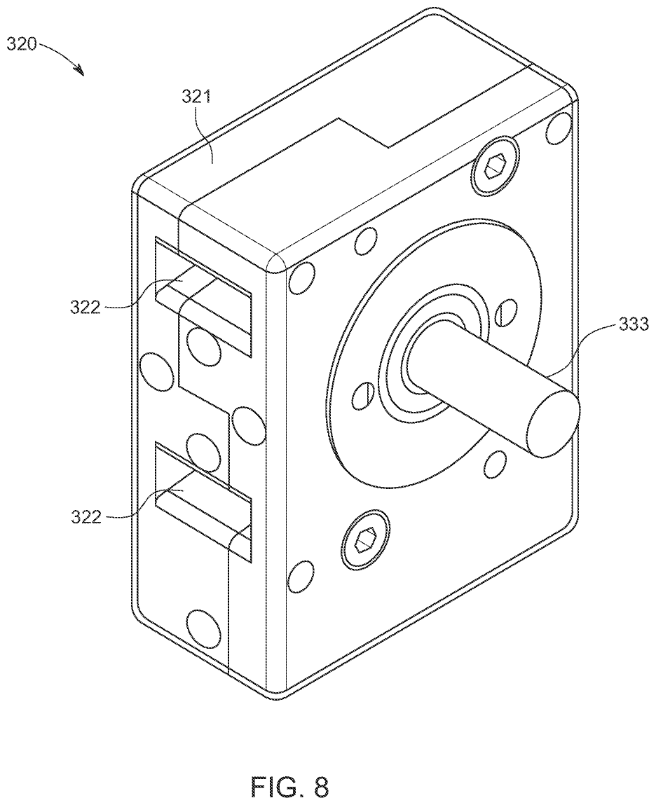

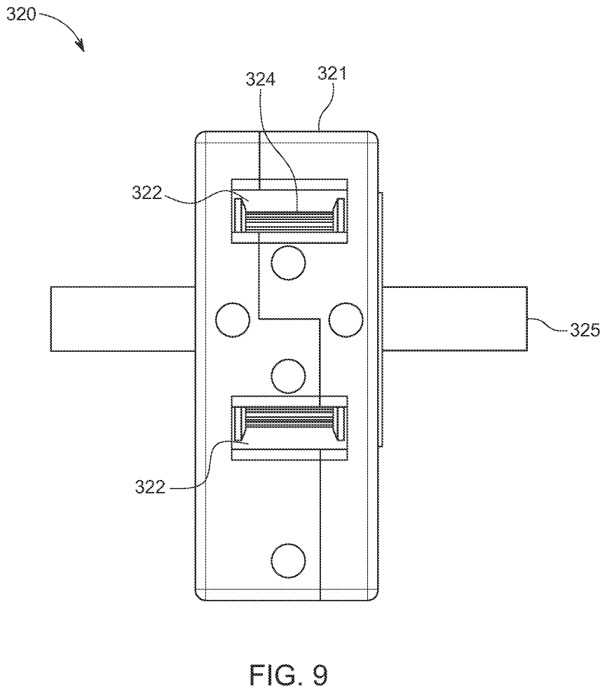

In an embodiment, the movable portion may be linearly actuated by two actuators 112 that cause the movable portion to move vertically along the rails. The two actuators 112 may be linearly actuators or any other type of actuator that may cause linear movement of the movable portion. The two actuators 112 may be joined together mechanically. In an embodiment, the actuators 112 may each be provided with a respective one of the rails 111. The actuators 112 may be driven by one or more motors 130. In an embodiment, the actuators 112 are each driven by a respective mechanical shaft with a respective gearbox and servo motor. In an embodiment, the actuators 112 are pulley systems 300 with respective belts 310 that are rotated by the respective motors 130, so as to cause linear movement of the movable portion of the bagger 100. An example of the pulley system 300 provided with a rail 111 is illustrated in FIGS. 4-7. As illustrated in FIGS. 4-7, the pulley system 300 may include a belt 310 that is provided in a first component 320 and a second component 330 at separate ends. The first component 320 and the second component 330 may each include a wheel in which the belt 310 may move along. The wheel of the first component 320 and/or the wheel of the second component 330 may act as a drive wheel. For example, the wheel of the component on the bottom side of the bagger 100 (e.g. the first component 320) may be a drive wheel. The drive wheel may be connected to the mechanical shaft which may be connected to the gearbox and servomotor which are configured to drive the belt 310 via the drive wheel. FIGS. 8-9 illustrate an example of the first component 320. As illustrated in FIGS. 8-9, the first component 320 may have a body 321 including slots 322 in which the belt 310 may enter and exit the body 321, and the body 321 may further include the wheel 324 that may be a drive wheel. The drive wheel may be connected to the mechanical shaft 325 which may be driven by a motor 130. The second component 330 may have a similar configuration to the first component 320.

In embodiments, the movable portion may include the movable gripper system 140. In an embodiment, the movable portion may include one or more belt drive mounts 340 that are held by the rails 111 and configured to be moved by the actuators 112 associated with the rails 111. An example of the belt drive mount 340 is illustrated in FIGS. 4-7. The belt drive mount 340 may hold the movable gripper system 140 (and/or other components) such that the movable gripper system 140 (and/or the other components) is configured to be moved by the actuators 112 associated with the rails 111.

The one or more rollers 120 may be provided with a tube stock film 10, and the baggers of the present disclosure may be configured to form and cut bags from the tube stock film 10. In an embodiment, the tube stock film 10 may be, for example, plastic. In an embodiment, the tube stock film 10 may be in the form of a tube, wherein lateral sides of the tube stock film are pre-joined before being provided on a roller 120 so as to only be open in an axial direction of the film. Accordingly, the tube stock film 10 may be wound on a roller 120 in a state in which only one side of the tube stock film 10 may need to be sealed and another side may need to be cut to form a bag. In an embodiment, the one or more rollers 120 may include a roller 120 in which a roll of the tube stock film 10 is mounted, and the roller 120 may rotate to enable the tube stock film 10 to unroll from the roll. As illustrated in FIGS. 1-3, the roller 120 may be mounted to a top of the support frame 110 so as to be at a top of the bagger 100. Alternatively, a roller 120 holding the tube stock film 10 may be provided at a backside of the bagger 100. As illustrated in FIGS. 1-2, the roller 120 may be provided with a tension knob 122, and the tension knob 122 may be configured to control the resistance of the roller 120 to rolling, thereby controlling a tension of the tube stock film 10 when unrolled from the roll.

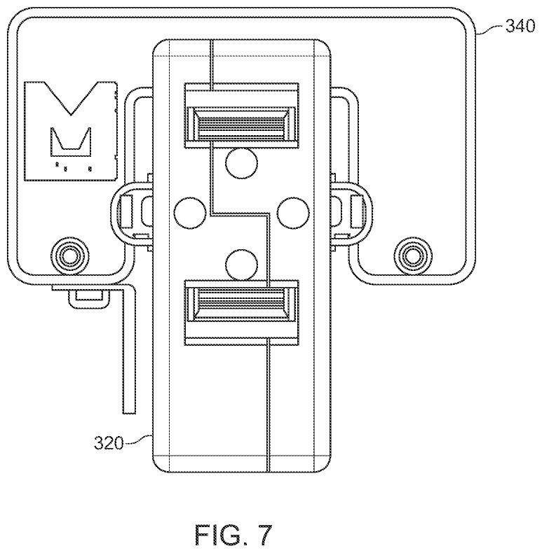

The movable gripper system 140 of embodiments of the present disclosure may be configured to grip the tube stock film 10 and move upward and downward with and without the tube stock film 10 being gripped by the movable gripper system 140. In an embodiment, the movable gripper system 140 may include one or more grippers 142 that are each provided with one or more respective pneumatic (e.g. air) actuated cylinders. In an embodiment, the movable gripper system 140 may include a pair of grippers 142 as illustrated in FIGS. 1-2, FIG. 3, or FIG. 7. The grippers 142 may be a pair of plates that open and close on opposite sides of the tube stock film 10 to grip and ungrip the tube stock film 10, respectively. The grippers 142 may be configured to open and close to mechanically grip and un-grip the tube stock film 10 by the one or more pneumatic actuated pneumatic cylinders provided with the grippers 142. Alternatively or additionally, the grippers 142 may be configured to grip (or be assisted in the gripping of) the tube stock film 10 by suction force. In an embodiment, the grippers 142 may be vacuum-aided grippers. For example, the movable gripper system 140 may include one or move vacuum devices (e.g. an air pump) that is configured to apply a suction force on the tube stock film 10, such that the grippers 142 grip the tube stock film 10. In an embodiment, the grippers 142 may grip edges of the tube stock film 10. The movable gripper system 140 may be configured to blow a slight amount of air towards the tube stock film 10 in cases in which gripping and movement of the tube stock film 10 is to be avoided. For example, the one or more vacuum devices may be configured to also blow the air. The one or more vacuum devices may include at least one motor configured to cause the suction force and the blowing of air. In an embodiment, the grippers 142 of the movable gripper system 140 may be configured to grip a part of the tube stock film 10 corresponding to an end of a bag.

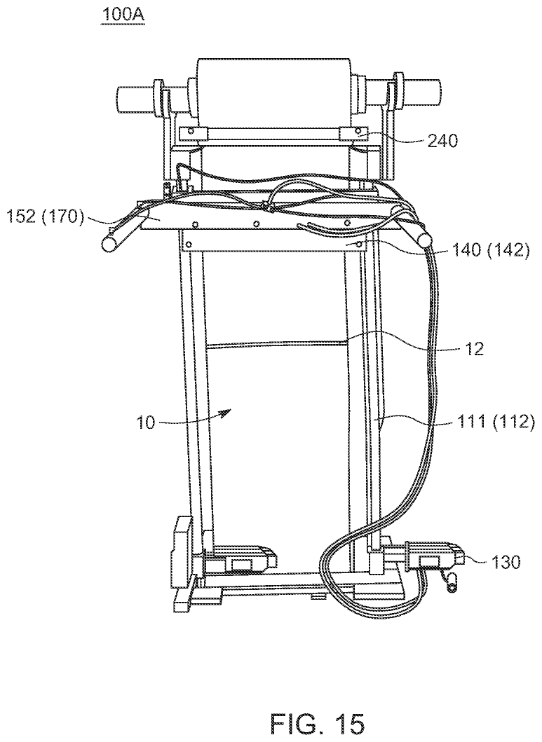

With reference to FIGS. 1-3 and 16, the seal system 150 may comprise a seal bar 152 and one or more actuators 153 configured to actuate the seal bar 152 to perform a seal process on the tube stock film 10 to form a bag. For example, the seal bar 152 may be configured to seal the tube stock film 10 along a lateral direction of the tube stock film 10 so as to form a sealed end of the bag. An example of the sealed end 12 is illustrated in FIGS. 3 and 15. In an embodiment, the sealed end 12 may be a top end or a bottom end of the bag. The one or more actuators 153 may be a pneumatic actuator that is, for example, a linear actuator, and the seal bar 152 may be a pneumatic (e.g. air) actuated seal bar. In an embodiment, the seal bar 152 of the seal system 150 may be the bag seal bar described in U.S. Pat. No. 6,862,867, which is incorporated by reference. The seal bar 152 may include at least one thermal element and at least one contact surface that is configured to contact the tube stock film 10 when the seal bar 152 is actuated by the one or more actuators 153 of the seal system 150, thereby causing the at least one thermal element to seal opposite faces of the tube stock film 10 together via heat. With reference to FIG. 3, the seal system 150 may be a part of the movable portion, and move vertically with the movable gripper system 140 when the actuators 112 provided with the rails 111 are actuated. For example, the seal system 150 may be mounted to the movable gripper system 140, along with a cutting device (e.g. a cutter 170 described below), and move with the movable gripper system 140 as one unit. Alternatively, the seal system 150 may be mounted on the support frame 110 so as to be configured to move independently of the movable gripper system 140. In an embodiment, the seal system 150 may be thermally separated from other apparatuses (e.g., cutting device, movable gripper system 140, etc.) for the seal system 150 and the other apparatuses to function properly. In an embodiment, hoses 155 for actuating the one or more actuators 153 (e.g. pneumatic linear actuator(s)) of the seal bar 152 may be provided.

Referring to FIGS. 1-3, a cutter 170 may be provided. The cutter 170 may comprise a knife with a blade that is configured to cut the bag from the tube stock film 10, and the cutter 170 may further comprise one or more actuators 172 (e.g. pneumatic linear actuator(s)) configured to move the knife to cut the bag. The one or more actuators 172 may be a pneumatic (e.g. air) actuator that are, for example, linear actuators, and the knife may be a pneumatic (e.g. air) actuated flying knife. The cutter 170 may be provided as a part of the movable portion of the bagger 100. In an embodiment, hoses 175 for actuating the one or more actuators 172 (e.g. pneumatic linear actuator(s)) of the cutter 170 may be provided.

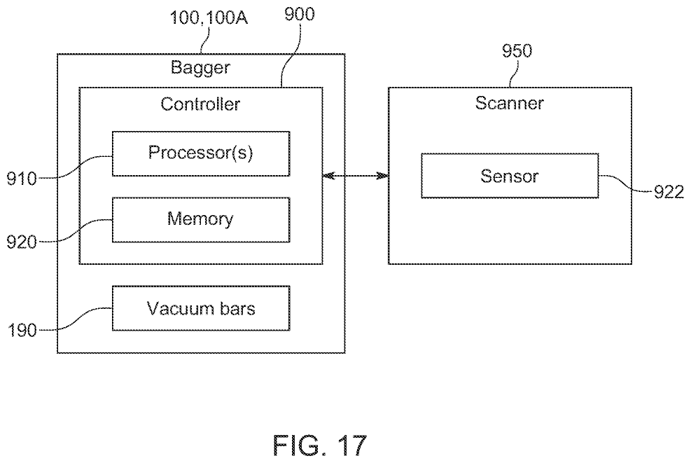

Referring to FIG. 17, the bagger 100 (or bagger 100A) may also include a controller 900 comprising at least one processor 910 with memory 920 including computer program code. The computer program code, when executed by the at least one processor 910, may be configured to cause the controller 900 to control any number of components of the bagger 100 to perform its functions (e.g. moving, gripping, un-gripping, sealing, heating, etc.). For example, the controller 900 may be caused to generate and send a signal(s) to the components that causes the components to be manipulated (e.g. to move, to grip, to start heating, etc.) according to control methods, including those known to persons of ordinary skill in the art, to perform their respective functions.

In embodiments, the bagger 100 may comprise printers that are attached to the support frame 110 using, for example, t slot nuts and mounting brackets. In an embodiment, the bagger 100 may comprise a printer head 162 (e.g. a printer) with, for example, a print head bracket(s) 160. The printer head 162 may be configured to print information on the tube stock film 10 that forms the bags. For example, the printer head 162 may print lot numbers, data codes, product IDs, barcodes, etc. The print head bracket(s) 160 may be attached to the actuators 112 on the rails 111 (e.g. belt driven actuators) by way oft slot nuts in extruded aluminum frames of the rails 111 with actuators 112.

With reference to FIG. 3, baggers (e.g. bagger 100 or bagger 100A) of the present disclosure may include a top holding grip system 240. The top holding grip system 240 may have a configuration similar to the movable gripper system 140, except the top holding grip system 240 may be mounted on the support frame 110 so as be stationary with respect to the vertical direction. For example, the top holding grip system 240 may be non-moveable in the vertical direction.

According to processes of the present disclosure, baggers of the present disclosure may be configured to, after a start button is pressed, make a bag(s) of a programmed length(s) by, for example, closing grippers of the bagger, activating actuators to move the grippers so as to pull the tube stock film to a predetermined length, and sealing the tube stock film to form a bag using the bag seal bar.

According to embodiments, an open end of the bag (e.g. a bottom end) may then be gripped by two vacuum bars 190 (refer to FIG. 17) of the bagger so as to be opened for loading of product automatically, or the bag may be cut and dropped in a bag shoot after cutting. The cutting may be performed by cutters of the present disclosure. The two vacuum bars 190 may be mounted on the support frame 110 of the baggers illustrated in FIGS. 1-3, for example on the rails 111, and be configured to apply a suction force on respective faces of opposite faces of the tube stock film so as to open the open end of the tube stock film 10. The two vacuum bars 190 may be provided with one or move vacuum devices (e.g. an air pump) that is configured to apply a suction force on the tube stock film, such that the vacuum bars 190 grip the tube stock film. The one or more vacuum devices may include a motor configured to cause the suction force. The two vacuum bars 190 may be a part of the movable portion and move vertically with the movable gripper system when the actuators are actuated. Alternatively, the seal system 150 may be mounted on the support frame 110 so as to be stationary, or mounted on the support frame 110 so as to be configured to move independently of the movable gripper system 140. The vacuum bars 190 and the vacuum devices provided therewith may be controlled by the controller 900.

After the first bag is made, a second bag may be sealed by the seal bar 152 of the seal system 150 as the tube stock film 10 is being pulled downward. This saves time and speeds up the processing by the bagger.

In embodiments, the bagger may further comprise printer units, RFID printers, labeling units, etc. In embodiments, a bagger system may be provided that includes any of the baggers of the present disclosure. The bagger system may further comprise a conveyor that is configured to move products to the bagger of the bagger system. The bagger system may further comprise a 3D scanner or others means that may scan product coming down the conveyor to the bagger. Accordingly, information of a size of the product can be obtained by the scanner and the bagger can create a programmed length bag based on the information. In other words, the bagger of the bagger system may be configured to make custom length bags based on the product(s) scanned. Accordingly, bag waste may be reduced and time may be saved.

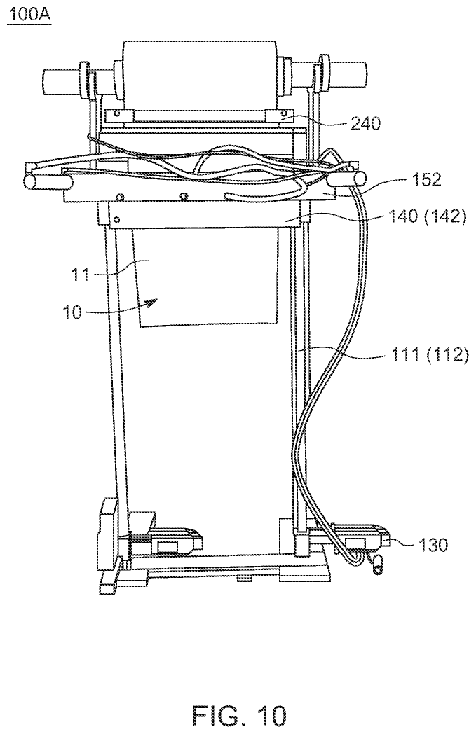

An example process performable by baggers of the present disclosure is provided below. Some stages of the process are described with reference to FIGS. 10-15.

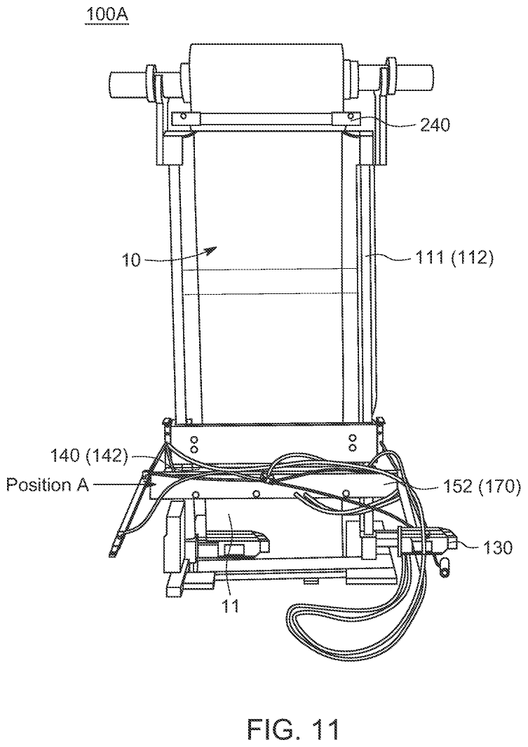

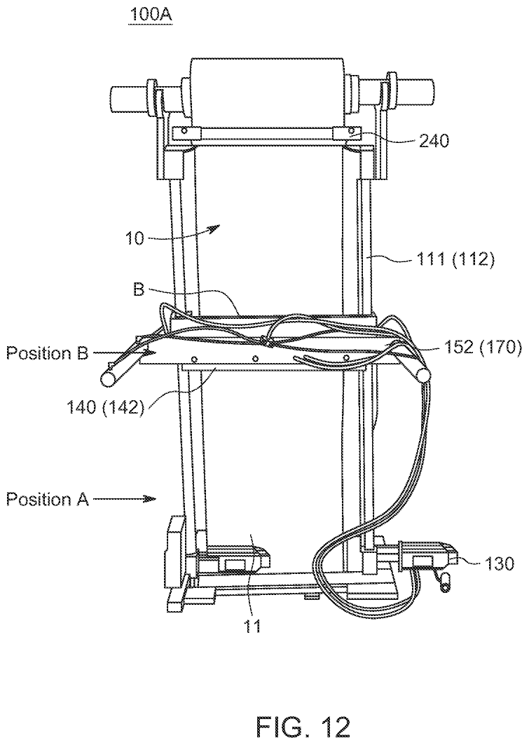

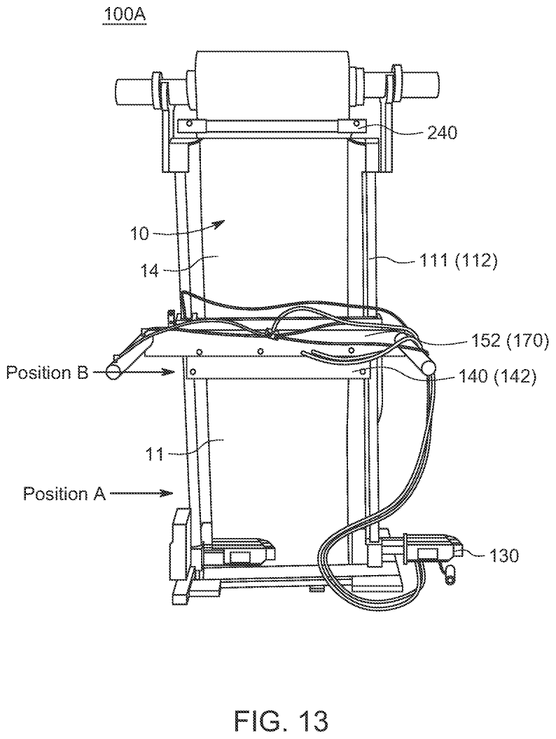

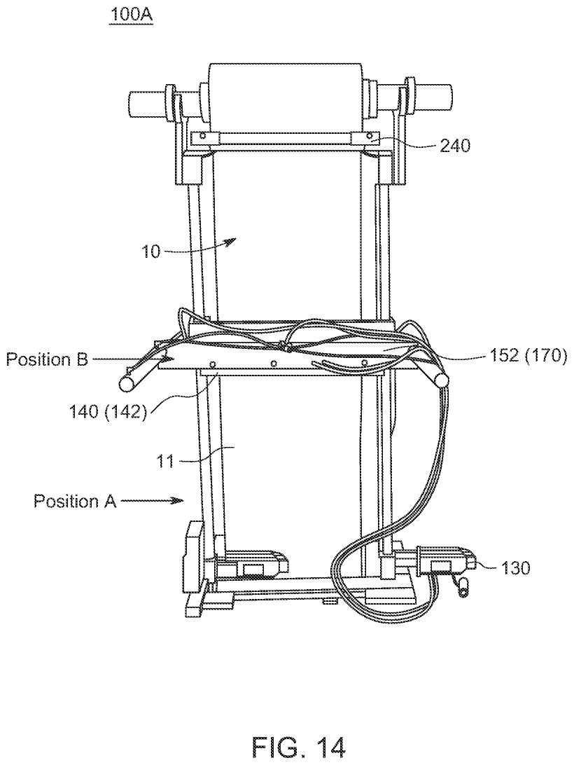

According to an embodiment, an operator of the bagger may feed the tube stock film 10 into the grippers 142 of the movable gripper system 140, and close guarding of the bagger. The guarding may refer to a guarding enclosure around any number of components of the bagger to prevent an operator from getting injured. The guarding may have to be opened by the operator for the operator to load the tube stock film 10 into the bagger, and when closed, the guarding may prevent the operator from physically interacting with the tube stock film 10 and any number of other components of the bagger so at to avoid injury. With reference to FIG. 10, after a start button of the bagger is pressed, the controller 900 may cause the grippers 142 of the movable gripper system 140 to close so as to grip the tube stock film 10 at a portion 11 of the tube stock film 10 corresponding to, for example, a bottom end of a bag to be formed. With reference to FIG. 11, the controller 900 may then control the grippers 142 to move a predetermined amount in a first direction (e.g. a downward direction) to a first predetermined position A (while gripping portion 11 of the tube stock film), based on a manually inputted length or a length determined based on information from a scanner 950 (refer to FIG. 17) that includes a sensor 922 (e.g. an image scanner that includes an image sensor) and any offsets. For example, the controller 900 may control the motors 130 to move the actuators 112 associated with the rails 111 a specified amount so as to cause the grippers 142 to move to the first predetermined position in the first direction, and the grippers 142 causing a predetermined length of the tube stock film 10 to be available for forming the bag within the bagger. The scanner information may include information about a size of a product to be inserted into the bag. The scanner information may be obtained by the scanner 950 by scanning the product and may be sent to the controller 900 by wired or wireless communication. With reference to FIG. 12, the controller 900 may then cause the grippers 142 to un-grip the tube stock film 10 by opening, and move in a second direction (e.g. an upward direction) to a second predetermined position B. The second predetermined position B may be at or nearby a portion of the tube stock film 10 corresponding to a top end of the bag to be formed. While the grippers 142 are moving in the second direction to the second predetermined position B, the controller 900 may cause the movable gripper system 140 (or another portion of the bagger) to provide a slight amount of air to be blown on a side (e.g. a backside) of the tube stock film 10 to avoid accidental gripping or movement of the tube stock film 10. Once the grippers 142 reach the second predetermined position B, the controller 900 may cause the grippers 142 of the movable gripper system 140 to close so as to grip the tube stock film 10, and further cause the top holding grip system 240 to close so as to also grip the tube stock film 10. In an embodiment, the top holding grip system 240 may close so as to grip the tube stock film 10 any time after the grippers 142 of the movable gripper system 140 reach the first predetermined position A. For example, the top holding grip system 240 may close while the grippers 142 are stationary at the first predetermined position A or moving towards the second predetermined position B. While the top holding grip system 240 and the grippers 142 of the movable gripper system 140 are in the gripped state, the controller 900 may then control the motors 130 to move the grippers 142 of the movable gripper system 140 downward so as to cause the tube stock film 10 to be tensioned between the grippers 142 of the movable gripper system 140 and the top holding grip system 240. With reference to FIG. 13, while portion 14 the tube stock film 10 is tensioned, the controller 900 may control the seal system 150 (that includes the seal bar 152) to be operated for a set amount of time and pressure to seal the top end of the bag. For example, the controller 900 may control the one or more actuators 153 of the seal system 150 to actuate the seal bar 152 into a contact state with the tube stock film 10, and heat the tube stock film 10 with the seal bar 152 to cause the tube stock film 10 to be sealed at a portion corresponding to a top end of the bag. For example, the sealed portion may be the sealed end 12 shown in FIGS. 3 and 15. With reference to FIG. 14, the controller 900 may cause the one or more actuators 153 of the seal system 150 to actuate the seal bar 152 so as to separate from the tube stock film 10 when a set heating time passes so as to finish the seal process. During and/or after the seal process, the controller 900 may control the grippers 142 of the movable gripper system 140 to grip a portion of the top end of the bag for presentation (e.g. tensioning the top end of the bag), and control the knife of the cutter 170 to actuate to cut the top end of the bag from the remainder of the tube stock film 10, so as to separate the bag from the tube stock film 10. In an embodiment, the top holding grip system 240 may be controlled to grip or maintain grip of a portion of the tube stock film 10, above the top end of the bag, such that the top end of the bag is tensioned between the top holding grip system 240 and the movable gripper system 140 for the cutting. In an embodiment, the movable gripper system 140 may be controlled to un-grip the bag after the cutting, while the top holding grip system 240 maintains grip of the portion of the tube stock film 10 above the bag, such that the bag is enabled to fall away due to the cutting.

On the second and following cycles for forming bags, the controller 900 may control the bagger to seal subsequent bags while the tube stock film 10 is pulled to length by the movable gripper system 140 gripping and downwardly moving the tube stock film. Accordingly, time may be saved. The process may be repeated.

In an embodiment, during a first cycle for forming a bag, the bagger may pull an open section of the tube stock film 10 (e.g. a bottom of the bag to be formed) to a bottom position, then release the grippers 142 of the movable gripper system 140, move to the sealing position (e.g. a position corresponding to a top end of the bag to be formed), then perform the sealing and cutting operations. In an embodiment, an accurate first bag length and/or positions of the tube stock film 10 (e.g. a position of the unrolled tube stock film) may be identified and stored in memory of the bagger based on the first cycle.

In an embodiment, after the first cycle, the bagger may be configured to move directly to the sealing and cutting position of a second bag (e.g. a top end of the second bag), based on an identified position of the tube stock film 10 from the first cycle. Accordingly, the bagger may be configured to move directly to the sealing and cutting position and perform these operations while the movable gripper system 140 pulls the tube stock film downward to form the second bag of a correct length.

According to an embodiment with reference to FIG. 15 (which shows the first bag still attached for demonstration or other purposes), after the first bag is cut and the movable gripper system 140 releases the first bag, the second cycle may include moving the movable gripper system 140 to a position corresponding to an intended bag length (e.g. a top end of the second bag) and then closing the movable gripper system 140. Following, the top holding grip system 240 may be controlled to un-grip the tube stock film 10, and the movable gripper system 140 may be controlled to move downward while gripping the tube stock film 10 such that the tube stock film 10 is pulled downwards. During such downward movement while the movable gripper system 140 is in a closed state, the seal bar 152 may be controlled to seal the tube stock film 10 to form an end (e.g. a top end) of a second bag. Based on the movable portion of the bagger and/or the tube stock film 10 reaching a predetermined position (e.g. a position stored in the memory of the bagger), the bagger may control the top holding grip system 240 to grip the tube stock film 10 while the tube stock film 10 is continued to be pulled downed by the movable gripper system 140. Accordingly, the tube stock film 10 may be tensioned. While the tube stock film 10 is tensioned, the bagger may control the cutter 170 to cut the tube stock film 10, and the movable gripper system 140 to un-grip the second bag such that the second bag falls away from the remainder of the tube stock film 10. In an embodiment, the process of the second cycle may then be repeated to perform subsequent cycles. In an embodiment, the controller 900 of the bagger may be configured to control the bagger to perform the cycles.

It should be noted that although a few embodiments have been described, those skilled in the art will readily appreciate that many modifications are possible to the embodiments without materially departing from the novel teachings and advantages of the embodiments. Accordingly, all such modifications are intended to be included within the scope of the embodiments. Therefore, it is to be understood that the foregoing is illustrative of various embodiments and is not to be construed as limited to the specific embodiments illustrated.

What is claimed is:

1. A bagger comprising:
a support frame comprising two rails;
a movable portion comprising a seal system and a gripper system, the movable portion attached to the two rails of the support frame;
actuators including a first actuator and a second actuator, the first actuator and the second actuator each configured to move the movable portion along a respective rail of the two rails of the support frame, simultaneously; and
a roller configured to hold a roll of film, the roller connected to a portion of the support frame, wherein
the gripper system includes at least one body that is configured to grip the film, and
the seal system includes a seal bar that is configured to heat seal opposite side faces of the film together so as to form a first end of a bag.

2. The bagger of claim 1, further comprising:
two vacuum bars that are each configured to grip a respective side face of the opposite side faces of the film such that a portion of the film, corresponding to a second end of the bag, is opened.

3. The bagger of claim 1, further comprising:
a cutting device comprising an actuator and a knife, the actuator configured to cause the knife to separate the bag from another portion of the film by cutting the film.

4. The bagger of claim 3, further comprising:
a bag shoot configured to receive the bag after the bag is separated from the another portion of the film by the knife.

5. The bagger of claim 1, further comprising:
a first motor and a second motor, wherein
the first actuator comprises a first pulley system comprising a belt and at least two wheels on which the belt of the first pulley system is provided,
the second actuator comprises a second pulley system comprising a belt and at least two wheels on which the belt of the second pulley system is provided,
the first motor is configured to move the belt of the first pulley system by causing a wheel of the at least two wheels of the first actuator to move,
the second motor is configured to move the belt of the second pulley system by causing a wheel of the at least two wheels of the second actuator to move, and
the movable portion is configured to move with the belt of the first pulley system and with the belt of the second pulley system.

6. The bagger of claim 3, further comprising:
a controller comprising at least one processor and memory, the controller configured to:
control the gripper system to move a predetermined amount along the two rails in a first direction to a first position while gripping the film;
control the gripper system, after the gripper system reaches the first position, to ungrip the film and move to a second position in a second direction, opposite to the first direction;
control the gripper system, after the gripper system reaches the second position, to grip the film and tension the film;
control the seal system, while the film is tensioned by the gripper system, to seal a portion of the film, the portion of the film corresponding to the first end of the bag; and
control the cutting device to separate the bag from the another portion of the film.

7. The bagger of claim 6, further comprising:
an additional gripper system comprising at least one body that is configured to grip the film, wherein the additional gripper system is attached to the support frame above the gripper system, and
wherein the controller is configured to cause the gripper system to tension the film by controlling the additional gripper system to grip the film and controlling the gripper system to move away from the additional gripper system while the gripper system is gripping the film.

8. A bagger system comprising:
the bagger of claim 6;
a scanner comprising a sensor, the scanner configured to obtain a length of a product to be inserted into the bag, wherein
the bagger is configured to obtain the length of the product from the scanner and the controller of the bagger is configured to cause the bagger to form the bag based on the length.

9. The bagger of claim 1, wherein the seal system and the gripper system are configured to move together along the two rails of the support frame.

10. The bagger of claim 3, wherein the seal system, the cutting device, and the gripper system are configured to move together along the two rails of the support frame.

11. A method of forming a bag from a film by using a bagger, the method comprising:
controlling a gripper system of the bagger to move a predetermined amount along two rails of the bagger in a first direction to a first position while gripping the film;
controlling the gripper system, after the gripper system reaches the first position, to ungrip the film and move to a second position in a second direction, opposite to the first direction;
controlling the gripper system, after the gripper system reaches the second position, to grip the film and tension the film;
controlling a sealing device of the bagger, while the film is tensioned by the gripper system, to seal a portion of the film, the portion of the film corresponding to a first end of the bag; and
controlling a cutting device of the bagger to separate the bag from another portion of the film.

12. The method of claim 11, wherein the sealing device and the gripper system are configured to move together along rails of the bagger.

13. The method of claim 11, wherein the sealing device, the cutting device, and the gripper system are configured to move together along rails of the bagger.

14. The method of claim 11, further comprising:
controlling, after the bag is separated from the another portion of the film, the gripper system to move to a third position corresponding to a first end of another bag to be formed.

15. The method of claim 14, wherein
the bagger includes an additional gripper system including at least one body that is configured to grip the film, and
the gripper system is controlled to move to the third position while the gripper system is not gripping the film and the additional gripper system is gripping the film.

16. The method of claim 14, further comprising:
controlling the gripper system to move, from the third position, to a fourth position while the gripper system is gripping the film, and
controlling the sealing device to seal the film to form the first end of the another bag while the gripper system is moving to the fourth position.

17. The method of claim 16, further comprising:
controlling, after the gripper system reaches the fourth position, the cutting device of the bagger to separate the another bag from an additional portion of the film.

18. The method of claim 11, wherein the first position is predetermined based on information indicating a length of a product obtained from a scanner.

19. The method of claim 11, wherein
the bagger includes an additional gripper system including at least one body that is configured to grip the film, and
the gripper system, after reaching the second position, tensions the film by moving away from the additional gripper system while both the gripper system and the additional gripper system grip the film.

20. The method of claim 11, wherein
the bagger includes vacuum bars that are each configured to grip a respective side face of opposite side faces of the film, and
the method further comprises controlling, after the portion of the film corresponding to the first end of the bag is sealed, the vacuum bars to open a second end of the bag.
